(19) United States
(12) Patent Application Publication
(10) Pub. No.: US 2012/0251069 A1
(43) Pub. Date: Oct. 4, 2012

(54) Audio enhancement based on video and/or other characteristics

(75) Inventor: Ike A. Ikizyan, Newport Coast, CA (US)

(73) Assignee: BROADCOM CORPORATION, IRVINE, CA (US)

(21) Appl. No.: 13/074,244

(22) Filed: Mar. 29, 2011

(51) Int. Cl. H04N 5/93; H04N 5/765

(52) U.S. Cl. 386/230; 386/285; 386/E05.002; 386/E05.028

(57) ABSTRACT

Audio enhancement based on video and/or other characteristics. Information associated with a media signal is employed to modify an audio signal portion thereof. When undergoing playback, a modified audio signal enhances a perceptual experience for a user (e.g., a listener, a viewer, etc.). Based on information from any desired source, an audio signal may undergo certain modification so that, when played back, the modified audio signal enhances a user's perceptual experience. For example, information related to a scene (e.g., foreground, background, etc.) of a media signal (e.g., extracted from an image frame of a video signal thereof) may be used to modify the audio effects of the audio signal portion of the media signal. In addition, information related to the position of an audio source (e.g., such as a location of a speaker/character in a film) may be used to modify the audio signal to reflect that audio source's location.

### BACKGROUND OF THE INVENTION

1. Technical Field of the Invention

The invention relates generally to processing and outputting of media; and, more particularly, it relates to processing audio based on characteristic(s) associated therewith thereby enabling and providing an enhanced perceptual experience for a user.

2. Description of Related Art

Various systems and/or devices operate to output media for user consumption. For example, various systems and/or devices can playback media (e.g., video, audio, etc.) for or as directed by a user. For example, any of a variety of devices (e.g., televisions, media players, audio players, etc.) may be employed for playing back media for enjoyment and consumption by a user.

Such media may come from any of a variety of sources (e.g., from the Internet, from a content service provider [such as a cable, satellite, etc. service provider], from a local sources [such as a memory storage device, a CD, a DVD, etc.], from some combination thereof, etc). While there has been a great deal of effort to provide for improved user experience in regards to media consumption for many years, yet there seems to be an ever increasing demand for even greater improvements in the art.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 and FIG. 2 illustrate various embodiments of communication systems.

FIG. 3A illustrates an embodiment of a computer.

FIG. 3B illustrates an embodiment of a laptop computer.

FIG. 3C illustrates an embodiment of a high definition (HD) television.

FIG. 3D illustrates an embodiment of a standard definition (SD) television.

FIG. 3E illustrates an embodiment of a handheld media unit.

FIG. 3F illustrates an embodiment of a set top box (STB).

FIG. 3G illustrates an embodiment of a digital video disc (DVD) player.

FIG. 3H illustrates an embodiment of a generic digital image processing device.

FIG. 4 illustrates an embodiment of a device operative to identify at least one audio playback parameter based on at least one characteristic of a media signal.

FIG. 5 and FIG. 6 illustrate alternative embodiments of a device operative to identify at least one audio playback parameter based on at least one characteristic of a media signal.

FIG. 7 illustrates an embodiment of playback of a media signal in which an audio signal thereof is operative to undergo playback in accordance with at least one audio playback parameter.

FIG. 8 illustrates an embodiment of some characteristics associated with a media signal that may be extracted from at least one frame of a video signal.

FIG. 9A, FIG. 9B, FIG. 10A, and FIG. 10B illustrate various embodiments of methods for processing media signals in accordance with determining and/or employing at least one audio playback parameter.

### DETAILED DESCRIPTION OF THE INVENTION

A variety of devices and communication systems may operate using signals that include media content. In some embodiments, a media signal is a video signal (e.g., including both video and audio components), and in others, such a media signal may be an audio signal with no corresponding or associated video signal component. In accordance with playback of such a media signal, an associated audio signal can be output in such a manner as to enhance the perceptual experience of a user (e.g., a viewer such as in the case of a video signal, a listener such as in the case of an audio signal, etc.).

Information employed to modify or enhance an audio signal may come from any of a variety of sources. For example, in some embodiments, the information is extracted from the corresponding or associated video signal component itself. The video signal undergoes processing to identify certain characteristic(s) thereof. Information related to the type of scene depicted in one or more frames of a video signal (e.g., being indoors, outdoors [e.g., as ascertained by a sky region], within a concert hall, large room, small room, etc.) can be extracted from the video signal using various recognition means. For example, a characteristic associated with the media signal may be determined based on image information associated with one or more frames of the video signal, and such a characteristic may be used to modify the audio signal portion of a media signal and/or direct the manner by which the audio signal is output. Such image information may correspond to any one or more (any combination) of a color, a contrast, a brightness, a background, a foreground, an object, an object location, a change of the color, a change of the contrast, a change of the brightness, a change of the background, a change of the foreground, a change of the object, and a change of the object location, etc.

For example, information may be attained in accordance with certain operations performed in a video signal as well. For example, information may be extracted from a video signal in accordance with 2D to 3D conversion of the video signal. As one example of a specific type of information attained in 2D to 3D conversion, depth information can be extracted from 2D video and used to render two independent views representing a stereo pair (e.g., thereby generating 3D video). This stereo video pair is then viewed by the audience who then perceives the content as 3D. Video features such as this depth information can also be used to enhance the audio soundtrack in several novel ways. It is also noted that other processing operations of video may also provide various types of information that may be used, at least in part, to assist in the modification or enhancement of an audio signal and/or the playback thereof.

In another embodiment, information employed to modify or enhance an audio signal may come from meta data associated with the media signal. Generally speaking, meta data can include information that is descriptive of and related to the data or content itself. For example, depending on the type of media, associated meta data can differ in type and the type of information included. For example, with respect to an audio type of media signal, associated meta data may include information related to title, artist, album, year, track number, genre, publisher, composer, locale of performance (e.g., studio, concert hall [live performance]) etc. In the instance of the media being of a video type, associated meta data may include information related to title, soundtrack type and/or format, production company, actors or characters, location(s) of production, etc. Of course, additional information may be included within such meta data as well in certain embodiments. There are also a variety of other types of information that may be included within (embedded within) or accompany a signal such as electronic program guide information, closed captioning information, tele-text, etc. Such additional information may also be extracted from a signal to assist in the modification or enhancement of an audio signal and/or the playback thereof.

In even other embodiments, information employed to modify or enhance an audio signal may come from an external source (e.g., such as a database including information related to media [video and/or audio], etc.). Generally speaking, any of a variety of types of information may be employed to assist in the modification or enhancement of an audio signal and/or the playback thereof.

Regardless of the particular source of the information used for the modification or enhancement of an audio signal and/or the playback thereof, such information may be employed to modify the audio signal and/or the playback thereof to augment and enhance performance thereof. In some instance, the audio signal itself is modified to generate a modified audio signal that, when played back, will effectuate the modified acoustics via an output device in accordance with the manner in which it has been modified. In other instances, real time adjustment of an audio output device is performed during the playback of the audio signal. For example, real time adjustment of one or more settings of an audio processor (e.g., such as an audio digital signal processor (DSP)) may be made to effectuate an enhanced or improved user experience during playback of the media signal.

For example, a multi-channel audio signal (e.g., a movie soundtrack) may be employed to provide a user experience that sound is emanating from a variety of directions. However, not all audio signals are multi-channel. Some multimedia content has only 2-channel stereo audio signal associated therewith or even single channel mono audio signal associated therewith. This can be because of a variety of reasons, including bandwidth limitations, the media signal not originally be created with multi-channel audio signaling therein, etc.

In one possible embodiment, 3D effects may be added to an audio signal based on, and coordinated with, depth cues extracted from the video. Real time depth information extracted from a video signal can be used to control audio processing (e.g., equalizer setting, matrixing of mono/stereo to multiple channels, fading, balancing, parametric control of audio digital signal processor (DSP) effects, etc.) to effectuate a perceptually enhanced user experience. An audio DSP can be employed to add various effects such as reverb or chorus effects. The parameters for these effects can be tied to the various characteristics (e.g., such as depth information described with respect to one embodiment). For example, if there is a wide range of depth in the video, then the reverb level can be increased to simulate a more cavernous chamber.

Such audio processing can be performed in real time during playback of a media signal (e.g., by real time adjustment of an audio output device). Alternatively, such processing may actually modify an audio signal so that when that modified signal undergoes playback (either presently or at a future time), such audio processing effects made to the original audio signal are realized. Such a modified audio signal may be stored in a storage devices (e.g., memory, a hard disk drive (HDD), etc.) and/or be provided via a communication link to at least one other device for storage therein. Of course, the modified signal may undergo playback immediately without any intervening storage thereof.

Many different types of devices and/or components may be employed to store such a modified signal (e.g., memory, a hard disk drive (HDD), etc.) and/or be provided via a communication link to at least one other device for storage therein.

Within many devices that use digital media such as digital video (which can include both image, video, and audio information), digital audio, etc., such media maybe communicated from one location or device to another within various types of communication systems. Within certain communication systems, digital media can be transmitted from a first location to a second location at which such media can be output, played back, displayed, etc.

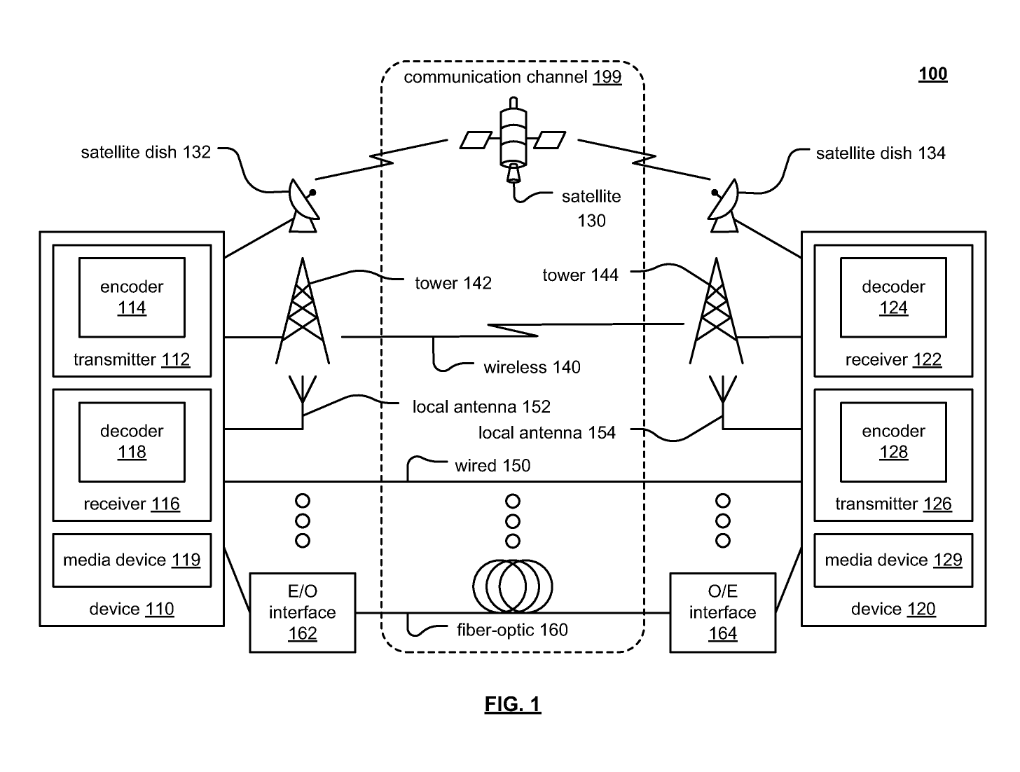

Generally speaking, the goal of digital communications systems, including those that operate to communicate digital video, is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well. In accordance with various aspects and principles, and their equivalents, of the invention, media may be provided via any number of pathways within any number of communication systems.

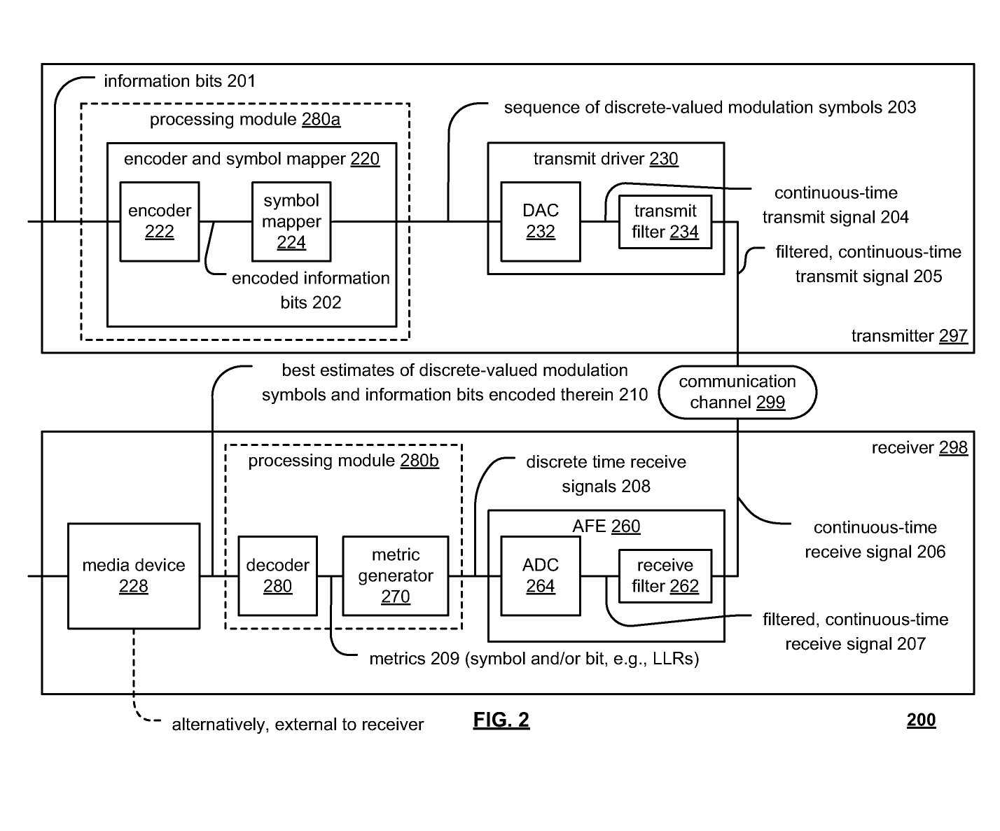

FIG. 1 and FIG. 2 illustrate various embodiments of communication systems, 100 and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199.

In some embodiments, one or both of the communication devices 110 and 120 may only include a media device. For example, the communication device 110 may include a media device 119, and/or the communication device 120 may include a media device 129. Such a media device as described herein may include a device operative to process a media signal, output a media signal (e.g., video and/or audio components thereof).

In certain embodiments, a media device may not be included within communication device 110 or communication device 120. For example, a media device may be connected and/or coupled to either of the communication device 110 or communication device 120. Also, in some embodiments, such a media device can be viewed as including or being connected and/or coupled to a display (e.g., a television, a computer monitor, and/or any other device includes some component for outputting video and/or image information for consumption by a user, etc.) and/or an audio player (e.g., a speaker, two or more speakers, a set of speakers such as in a surround sound audio system, a home theater audio system, etc.). With respect to this diagram, at each end of a communication channel, a media device may be implemented to perform processing, outputting, etc. of a media signal.

In certain embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which a media signal may be communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

Within the receiver 298, a media device 228 may be included therein. In other embodiments, a media device may not be included within receiver 298. For example, a media device may be connected and/or coupled to the receiver 298. Also, in some embodiments, such a media device can be viewed as including or being connected and/or coupled to a display (e.g., a television, a computer monitor, and/or any other device includes some component for outputting video and/or image information for consumption by a user, etc.) and/or an audio player (e.g., a speaker, two or more speakers, a set of speakers such as in a surround sound audio system, a home theater audio system, etc.). With respect to this diagram, at each the receiver end of the communication channel 299, a media device may be implemented to perform processing, outputting, etc. of a media signal.

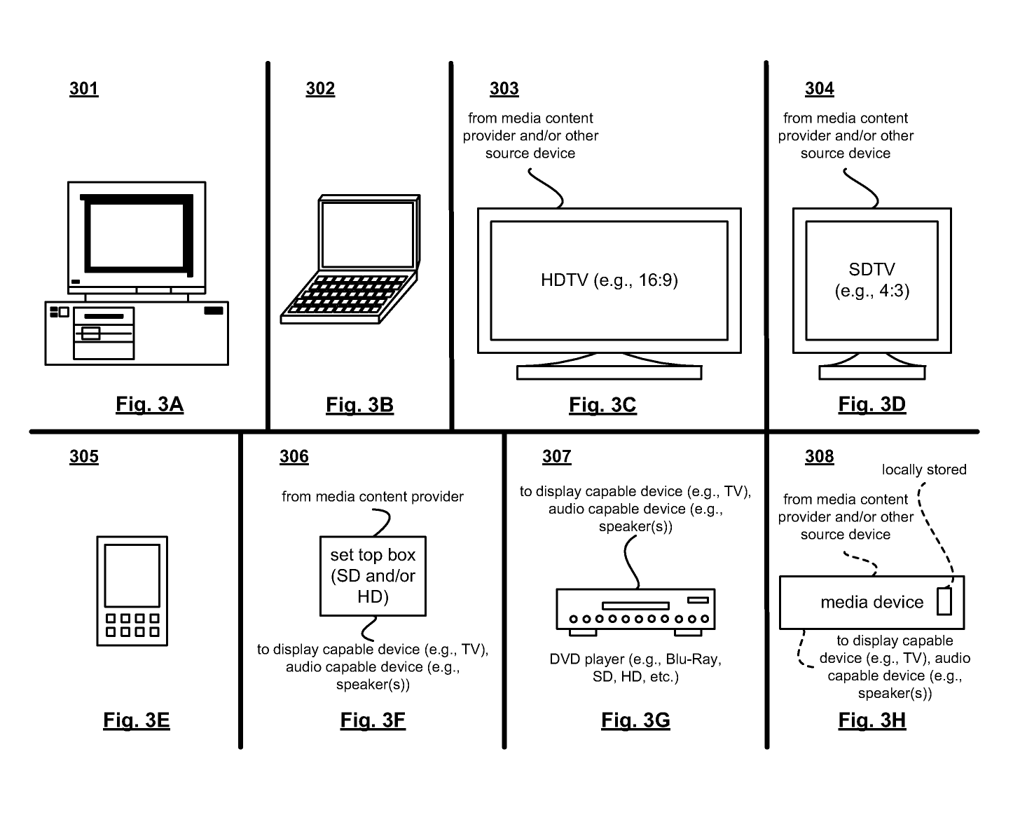

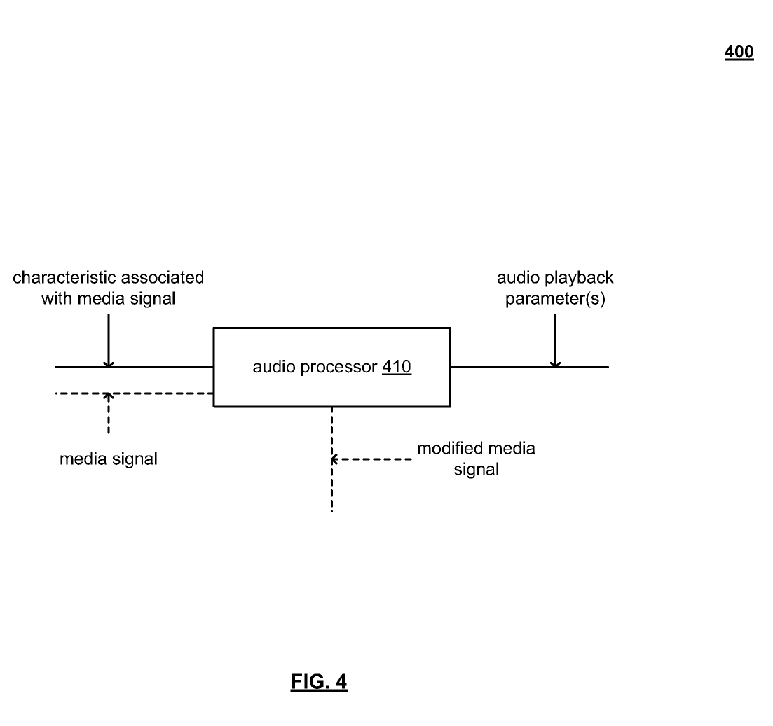

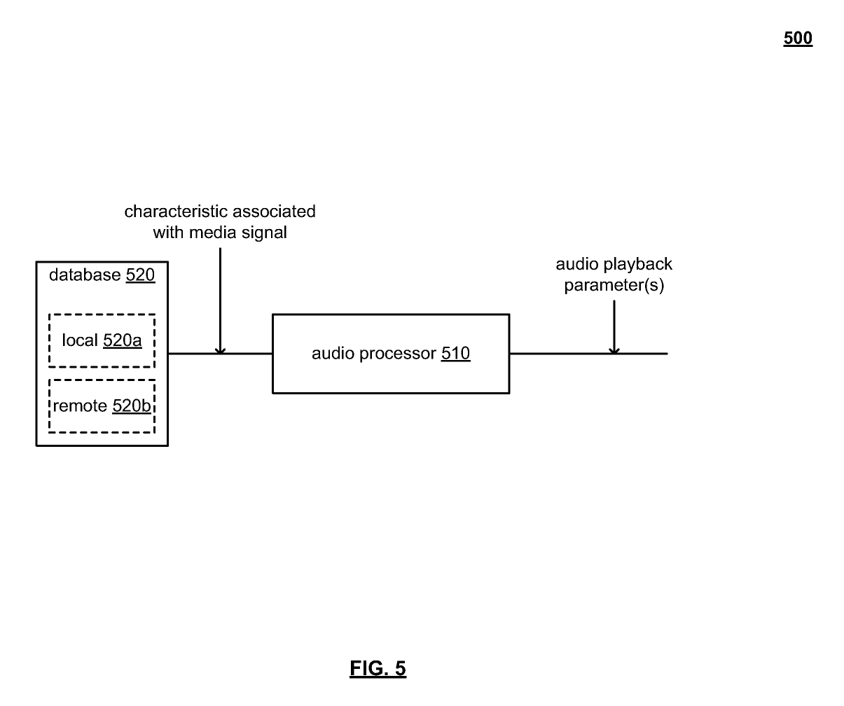

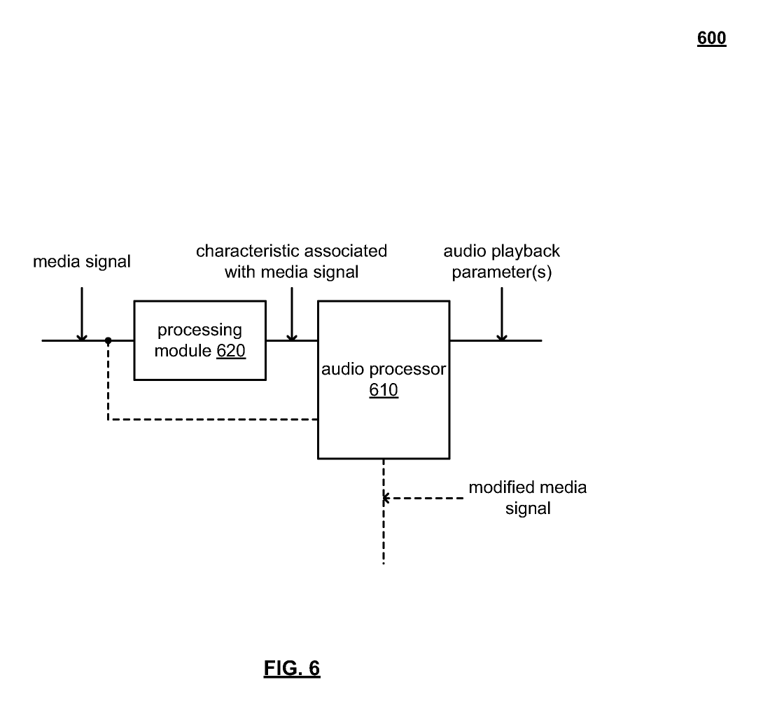

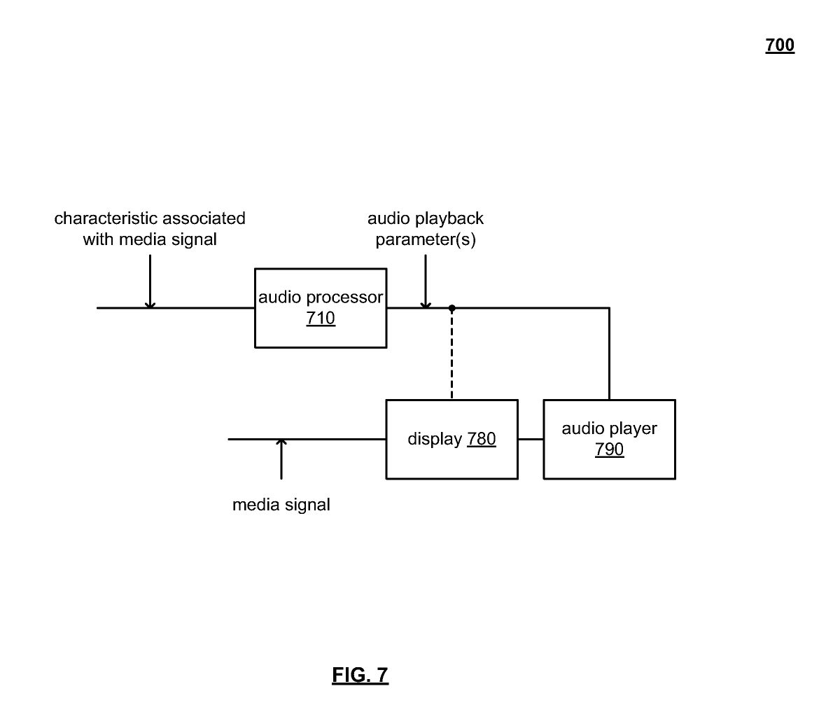

Processing of media signals (including the respective images within a digital video signal, the audio signal component thereof, etc.) may be performed by any of the various devices depicted below in FIG. 3A-3H to allow a user to view such digital images, video, audio, etc. These various devices do not include an exhaustive list of devices in which the media signal processing described herein may be effectuated, and it is noted that any generic media device may be implemented to perform the processing described herein without departing from the scope and spirit of the invention.

FIG. 3A illustrates an embodiment of a computer 301. The computer 301 can be a desktop computer, or an enterprise storage device such a server, or a host computer that is attached to a storage array such as a redundant array of independent disks (RAID) array, storage router, edge router, storage switch and/or storage director. A user is able to view still digital images or video (e.g., a sequence of digital images) using the computer 301. Oftentimes, various image viewing programs and/or media player programs are included on a computer 301 to allow a user to view such images, output video, and/or audio, etc.

FIG. 3B illustrates an embodiment of a laptop computer 302. Such a laptop computer 302 may be found and used in any of a wide variety of contexts. In recent years, with the ever-increasing processing capability and functionality found within laptop computers, they are being employed in many instances where previously higher-end and more capable desktop computers would be used. As with the computer 301, the laptop computer 302 may include various image viewing programs and/or media player programs to allow a user to view such images, output video, and/or audio, etc.

FIG. 3C illustrates an embodiment of a high definition (HD) television 303. Many HD televisions 303 include an integrated tuner to allow the receipt, processing, and decoding of media content (e.g., television broadcast signals) thereon. Alternatively, sometimes an HD television 303 receives media content from another source such as a digital video disc (DVD) player, set top box (STB) that receives, processes, and decodes a cable and/or satellite television broadcast signal. Regardless of the particular implementation, the HD television 303 may be implemented to perform image processing as described herein. Generally speaking, an HD television 303 has capability to display HD media content and oftentimes is implemented having a 16:9 widescreen aspect ratio.

FIG. 3D illustrates an embodiment of a standard definition (SD) television 304. Of course, an SD television 304 is somewhat analogous to an HD television 303, with at least one difference being that the SD television 304 does not include capability to display HD media content, and an SD television 304 oftentimes is implemented having a 4:3 full screen aspect ratio. Nonetheless, even an SD television 304 may be implemented to perform media signal processing as described herein.

FIG. 3E illustrates an embodiment of a handheld media unit 305. A handheld media unit 305 may operate to provide general storage or storage of image/video content information such as joint photographic experts group (JPEG) files, tagged image file format (TIFF), bitmap, motion picture experts group (MPEG) files, Windows Media (WMA/WMV) files, other types of video content such as MPEG4 files, etc. for playback to a user, and/or any other type of information that may be stored in a digital format. Historically, such handheld media units were primarily employed for storage and playback of audio media; however, such a handheld media unit 305 may be employed for storage and playback of virtually any media (e.g., audio media, video media, photographic media, etc.). Moreover, such a handheld media unit 305 may also include other functionality such as integrated communication circuitry for wired and wireless communications. Such a handheld media unit 305 may be implemented to perform media signal processing as described herein.

FIG. 3F illustrates an embodiment of a set top box (STB) 306. As mentioned above, sometimes a STB 306 may be implemented to receive, process, and decode a cable and/or satellite television broadcast signal to be provided to any appropriate display capable device such as SD television 304 and/or HD television 303. Such an STB 306 may operate independently or cooperatively with such a display capable device to perform media signal processing as described herein.

FIG. 3G illustrates an embodiment of a digital video disc (DVD) player 307. Such a DVD player may be a Blu-Ray DVD player, an HD capable DVD player, an SD capable DVD player, an up-sampling capable DVD player (e.g., from SD to HD, etc.) without departing from the scope and spirit of the invention. The DVD player may provide a signal to any appropriate display capable device such as SD television 304 and/or HD television 303. The DVD player 305 may be implemented to perform media signal processing as described herein.

FIG. 3H illustrates an embodiment of a generic media device 308. Again, as mentioned above, these various devices described above do not include an exhaustive list of devices in which the media signal processing described herein may be effectuated, and it is noted that any generic media device 308 may be implemented to perform the media signal processing described herein without departing from the scope and spirit of the invention.

FIG. 4 illustrates an embodiment 400 of a device operative to identify at least one audio playback parameter based on at least one characteristic of a media signal. In this embodiment 400, a characteristic associated with a media signal is provided via an input. In various embodiments, the media signal may be a video signal or an audio signal. When the media signal is a video signal, there is also an audio signal corresponding thereto. Also, when the media signal is a video signal, the video signal may be viewed as including a number of frames therein.

Based on the characteristic associated with a media signal, an audio processor 410 (e.g., such as an audio digital signal processor (DSP)) is operative to identify one or more audio playback parameters for use in playback of the audio signal to effectuate an audio effect corresponding to the characteristic. For example, a characteristic associated with media signal may be particularly associated with a video signal component thereof. In an embodiment in which the media signal is a video signal, the video signal may include a number of frames therein, and the characteristic associated with the media signal may be image information associated with one or more of the frames of the video signal. Any of a variety of aspects associated with or corresponding to one or more frames of a video signal including image information corresponding to any one of or any combination of a color, a contrast, a brightness, a background, a foreground, an object, an object location, a change of the color, a change of the contrast, a change of the brightness, a change of the background, a change of the foreground, a change of the object, and a change of the object location, etc. as may be determined from or related to one or more frames of a video signal.

Any one or any combination of audio playback parameters may be determined by the audio processor 410 for use in playback of the media signal and/or to modify the media signal itself (e.g., in accordance with generating a modified media signal). That is to say, examples of an audio playback parameter include, but are not limited to, a balance parameter, a fader parameter, an equalizer parameter, an audio effect parameter, a speaker parameter, a mono parameter, a stereo parameter, an audio high definition (HD) parameter, an audio three-dimensional (3D) parameter, and a surround sound parameter.

In addition, in some embodiments, an audio playback parameter may relate and be used for playing back an audio portion of the media signal in accordance with an audio mode that is greater than the actual properties of the audio portion of the media signal. For example, a certain audio playback parameter may direct a single channel mono audio signal to be played back in accordance with 2-channel stereo audio format. In another example, a certain audio playback parameter may direct a single channel mono audio signal or a 2-channel stereo audio format to be played back in accordance with a surround sound audio format (e.g., being a multi-channel audio format in which audio is selectively delivered to a number of speakers distributed around a given environment). In other words, based on at least one characteristic associated with a media signal, the audio processor 410 may identify an audio playback parameter to direct the playback of an audio portion of the media signal in accordance with an enhanced operational mode relative to the actual properties of the an audio portion of the media signal itself.

As mentioned elsewhere herein, some embodiments are operative to direct the playback of an audio portion of a media signal in accordance with one or more audio playback parameters as determined based on at least one characteristic of the media signal. In other embodiments, the audio processor 410 is operative to modify the audio signal of the media signal in accordance with the characteristic thereby generating a modified media signal. For example, this may be viewed, from certain perspectives, as generated an entirely new media signal having different audio format properties than the original media signal. Such a modified media signal (and if desired, the original media signal), may be stored in a memory for use in subsequent playback (e.g., a memory, hard disk drive (HDD), or other storage means within the same device including the audio processor 410, or located remotely with respect to that device). The modified media signal then includes any appropriate audio playback parameter(s) embedded therein, so that when played back, the enhancements will be effectuated. If desired in some embodiments, the modified media signal may even undergo subsequent processing to identify even additional audio playback parameter(s) that could further enhance the playback thereof (e.g., such as in multiple iteration embodiment in which additional audio playback parameter(s) could be identified in subsequent processing therein).

FIG. 5 and FIG. 6 illustrate alternative embodiments 500 and 600, respectively, of a device operative to identify at least one audio playback parameter based on at least one characteristic of a media signal.

For example, referring to the embodiment 500 of the FIG. 5, while certain embodiments, the characteristic associated with the media signal is meta data. Such meta data may be extracted from or accompany the media signal itself, or such meta data may be retrieved from a database 520. The database 520 may be local with respect to audio processor 510 (as shown in a block 520a), remote with respect to audio processor 510 (as shown in a block 520b). In some embodiments, the database 520 may be some combination of locally stored meta data/information and remotely stored meta data/information. Meta data retrieved from the database 520 may assist in the identification of one or more audio playback parameters for use in playing back an audio portion of the media signal.

In some instances, there may be some instances where the meta data associated with a media signal is less than complete (e.g., providing some information associated therewith, but missing some information). As an example with respect to audio type of media signal, perhaps the meta data associated therewith may include information related to title and artist, yet be deficient in failing to include information related to album, year, track number, and/or other meta data information. The meta data that is available could be used as a reference to identify the missing meta data from the database 520 to provide further details and characteristics associated with the media signal to assist more fully in the identification of one or more audio playback parameters for use in playing back an audio portion of the media signal.

As one possible example regarding the use of meta data in accordance with determining at least one audio playback parameter, considering the genre of an audio signal (e.g., classical, country, rock, pop, etc.), a particular equalizer setting may be selected as an one audio playback parameter based on the characteristic of genre. As another example, information within the meta data related to the artist of the audio signal may be used to select a particular equalizer setting (e.g., selecting an equalizer setting better suited for playback of pop music when the artist information from the meta data indicated a pop artist, selecting an equalizer setting better suited for playback of classical music when the artist information from the meta data indicated a classical composer, etc.). Also, information within the meta data may include information related to an environment in which the media was recorded or produced (e.g., studio recording [under very controlled conditions], live performance [such as in a stadium, concert hall, etc.], etc.). A respective audio playback parameter may relate to an equalizer setting better suited for the environment in which the audio signal portion was made (e.g., selecting a hall setting or live setting for the equalizer is the meta data indicating a live performance, selecting a studio equalizer setting of the meta data indicating a live performance, etc.).

For example, referring to the embodiment 600 of the FIG. 6, a device may include a processing module 620 for processing a media signal thereby identifying a characteristic associated with the media signal. An audio processor 610 then employs the characteristic identified by the processing module 620 in accordance with identifying at least one audio playback parameter based on the characteristic for use in playback of the audio signal to effectuate an audio effect corresponding to the characteristic. For example, in this embodiment 600, the media signal itself undergoes processing to identify the characteristic. For example, in a situation in which the media signal is a video signal (e.g., including both a video signal portion and an audio signal portion), the processing module 620 can operate on image information associated with one or more frames of the video signal in accordance with determining the characteristic.

Somewhat analogously to other embodiments, the audio processor 610 of this embodiment 600 may process the media signal to generate a modified media signal (e.g., which may be stored in some storage means for future use, transmitted to another device for playback or storage therein, etc.).

FIG. 7 illustrates an embodiment 700 of playback of a media signal in which an audio signal thereof is operative to undergo playback in accordance with at least one audio playback parameter. Based on one or more characteristics associated with a media signal, an audio processor 710 identifies one or more audio playback parameters that direct the playback of an audio portion of the media signal. These one or more audio playback parameters are provided to an audio player 790. The audio player 790 includes at least one speaker for outputting the audio signal in accordance with the one or more audio playback parameters.

In some instances, the one or more audio playback parameters may also be provided to a display 780 (e.g., a television, a computer monitor, and/or any other device includes some component for outputting video and/or image information for consumption by a user, etc.) so that a video portion of the media signal may be output thereby while the audio portion of the media signal is output by the audio player 790 in accordance with the one or more audio playback parameters. Some examples of audio playback parameters include, but are not limited to, a balance parameter, a fader parameter, an equalizer parameter, an audio effect parameter, a speaker parameter, a mono parameter, a stereo parameter, an audio high definition (HD) parameter, an audio three-dimensional (3D) parameter, and a surround sound parameter.

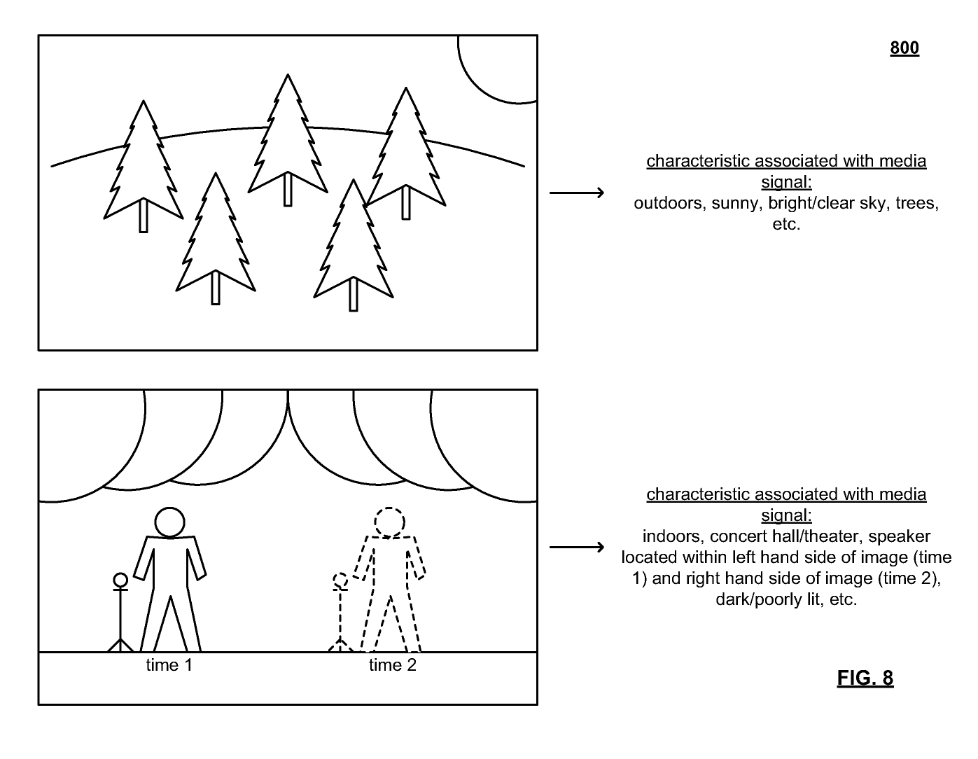

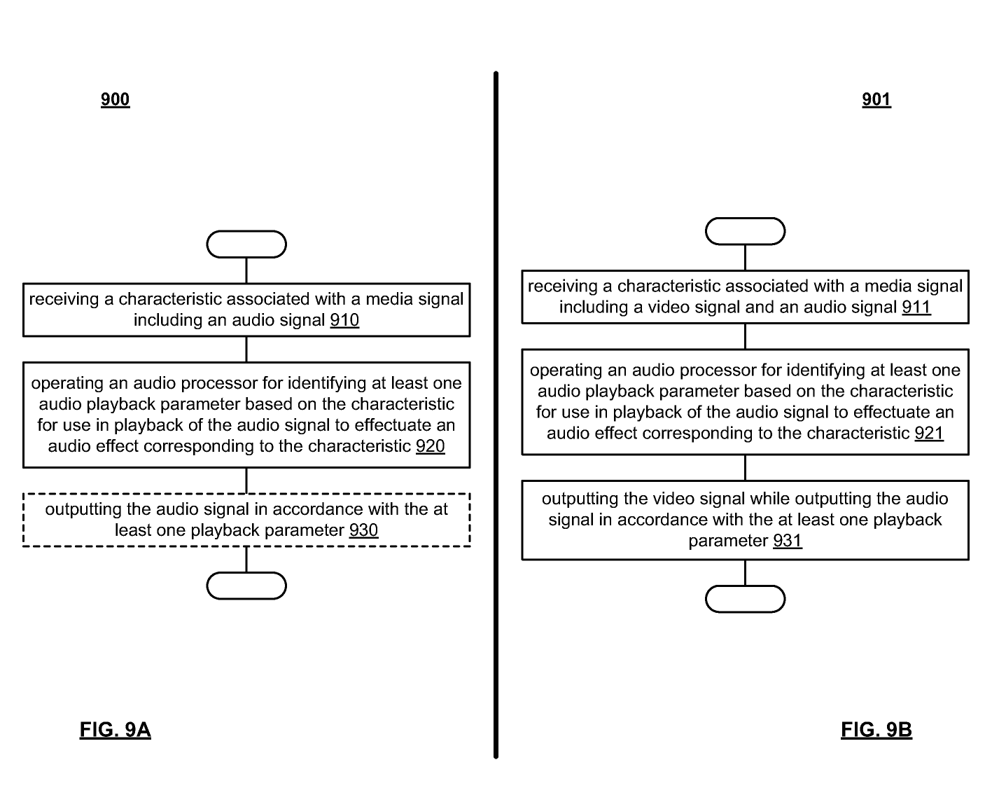

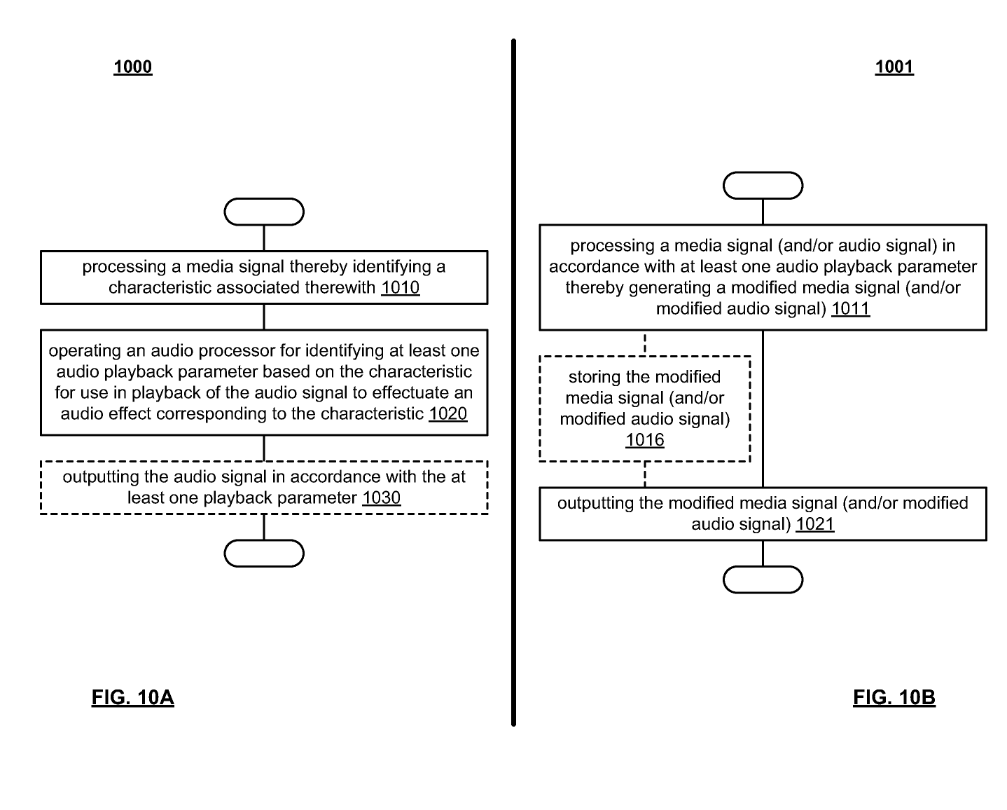

FIG. 8 illustrates an embodiment 800 of some characteristics associated with a media signal that may be extracted from at least one frame of a video signal. In an embodiment in which one or more frames of the video signal undergo processing to identify one or more characteristics associated with a media signal, a variety of types of characteristics could be identified.

For example, with respect to the image shown in the top portion of the diagram, various characteristics could be identified such as that the image depicts an outdoor image, that the environment is sunny and bright with a clear sky, and that the image depicts trees therein, etc. Various forms of pattern recognition may be employed to make such determination regarding various aspects of an image. For example, with respect to a sky being determined as predominately blue, a determination may be made that the sky is largely cloudless. With respect to the intensity and color of the pixels of the sky, a determination may be made as to time of day (e.g., darker blue pixels indicating night, with lighter blue pixels indicating day, etc.). Based on such determinations (e.g., an outdoor environment, etc.), one possible audio playback parameter may be an equalizer setting suited well for such an environment (e.g., such as to depict a very voluminous and open environment, etc.) for a better perceptual experience of a user.

For another example, with respect to the image shown in the bottom portion of the diagram, various characteristics could be identified such as that the image depicts a speaker located on a stage such as in a concert hall/theater. When considering different frames of the video signal, changes of one or more aspects of the image may also be employed as a characteristic. For example, one image may depict the speaker to be located on the left hand side thereof, while a subsequent image may depict the speaker to be located on the right hand side thereof. Based on the frame rate, and the number of frames that effectuate this transition of the speaker from the left hand side to the right hand side, a rate of movement of the speaker may also be determined. Analogously, depth of the speaker within various images may be used to ascertain movement of the speaker forward or backward on the stage as well.

Such characteristics as related to the location of the speaker, or the movement of the speaker, may be used to determine various audio playback parameters. For example, some possible audio playback parameters may include the adjustment of balance to correspond to the location of the speaker left or right, and dynamic adjustment thereof corresponding to the movement of the speaker across the stage, etc. Analogously, some additional possible audio playback parameters may include the adjustment of fader to correspond to the location of the speaker with regards to depth, and dynamic adjustment thereof corresponding to the movement of the speaker front and back on the stage, etc. Also, if a determination is made that the environment of the one or more images is in fact in a concert hall/theater, one possible audio playback parameter may be an audio equalizer setting suited well for such an environment (e.g., such as a hall setting, a clear setting, or live setting) for a better perceptual experience of a user. An audio equalizer setting may be one selected as suited better for playback of spoken audio content (e.g., speech as opposed to music).

Of course, as described elsewhere herein, image information such as any one or more (any combination) of a color, a contrast, a brightness, a background, a foreground, an object, an object location, a change of the color, a change of the contrast, a change of the brightness, a change of the background, a change of the foreground, a change of the object, and a change of the object location, etc. may be employed as a characteristic for use in identifying one or more audio playback parameters for use in playback of an audio signal to effectuate an audio effect corresponding to the characteristic.

As may generally be understood, one or more characteristics associated with a media signal, regardless of the source or the manner by which it is generated, is operative to identify one or more audio playback parameters for use in playing back an audio signal associated with the media signal in a modified manner. In some embodiments, such determination of one or more audio playback parameters is made in real time during processing of the media signal (or a portion thereof, such as associated meta data, video or image content thereof, etc.) and the one or more audio playback parameters is used to control the actual playback of the audio signal. In certain other embodiments, the determination of one or more audio playback parameters is made and the media signal itself undergoes modification thereby generating a modified media signal, so that when the modified media signal undergoes playback, the one or more audio playback parameters are already part thereof and will be realized.

FIG. 9A, FIG. 9B, FIG. 10A, and FIG. 10B illustrate various embodiments 900, 901, 1000, and 1001, respectively, of methods for processing media signals in accordance with determining and/or employing at least one audio playback parameter.

Referring to method 900 of FIG. 9A, the method 900 begins by receiving a characteristic associated with a media signal including an audio signal, as shown in a block 910. As mentioned in various embodiments, the characteristic associated with a media signal may come from any of a variety of sources (e.g., from meta data associated with the media signal, from processing the media signal or component thereof [such as video or image information thereof], etc.).

The method 900 continues by operating an audio processor for identifying at least one audio playback parameter based on the characteristic for use in playback of the audio signal to effectuate an audio effect corresponding to the characteristic, as shown in a block 920. For one possible example, to effectuate an audio effect associated with a characteristic of an image or video scene occurring outdoors could be effectuated by setting an equalizer setting of an audio player that is well suited for a voluminous, wide-open environment. Analogously, for yet another example, to effectuate an audio effect associated with a characteristic of an image or video scene occurring indoors [such as in a cavernous environment] could be effectuated by increasing a reverb level to simulate a more cavernous chamber.

In some embodiments, the method 900 also operates by outputting the audio signal in accordance with the at least one playback parameter, as shown in a block 930. For example, an audio player including at least one speaker (e.g., a speaker, two or more speakers, a set of speakers such as in a surround sound audio system, a home theater audio system, etc.) may be used to playback the audio signal as directed by the at least one playback parameter.

Referring to method 901 of FIG. 9B, the method 901 begins by receiving a characteristic associated with a media signal including a video signal and an audio signal, as shown in a block 911.

The method 901 then operates by operating an audio processor for identifying at least one audio playback parameter based on the characteristic for use in playback of the audio signal to effectuate an audio effect corresponding to the characteristic, as shown in a block 921.

The method 901 continues by outputting the video signal while outputting the audio signal in accordance with the at least one playback parameter, as shown in a block 931. For example, in accordance with outputting a video signal (that includes both video/image information as well as an associated audio signal), both the video signal component and the audio signal component could be output in synchronization with each other, yet the audio signal component being modified and enhanced in accordance with the at least one playback parameter.

Referring to method 1000 of FIG. 10A, the method 1000 begins by processing a media signal thereby identifying a characteristic associated therewith, as shown in a block 1010. The method 1000 continues by operating an audio processor for identifying at least one audio playback parameter based on the characteristic for use in playback of the audio signal to effectuate an audio effect corresponding to the characteristic, as shown in a block 1020.

In some embodiments, the method 1000 also operates by outputting the audio signal in accordance with the at least one playback parameter, as shown in a block 1030. For example, the

Referring to method 1001 of FIG. 10B, the method 1001 begins by processing a media signal (and/or audio signal) in accordance with at least one audio playback parameter thereby generating a modified media signal (and/or modified audio signal), as shown in a block 1011. From certain perspectives, such a modified media signal (and/or modified audio signal) may be viewed as being a newly-authored media signal modified (and/or newly-authored audio signal) in which the additional, new content is added thereto thereby generating a new artistic work.

The method 1001 then operates by outputting the modified media signal (and/or modified audio signal), as shown in a block 1021. That is to say, the modified media signal (and/or modified audio signal) may be output via a media and/or audio player such that the audio signal component thereof being modified and enhanced in accordance with the at least one playback parameter.

In some embodiments, the method 1001 also operates by storing the modified media signal (and/or modified audio signal) in between the operations of the blocks 1011 and 1021, as shown in a block 1031. Such storage could be made in a local storage device and/or a remotely located storage device. Examples of such storage devices include hard disk drives (HDDs), read-only memory (ROM), random access memory (RAM), volatile memory, non-volatile memory, static memory, dynamic memory, flash memory, and/or any device that stores digital information.

It is noted that the various modules and/or circuitries (e.g., encoding modules and/or circuitries, decoding modules and/or circuitries, audio processors, processing modules, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory (ROM), random access memory (RAM), volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

It is also noted that any of the connections or couplings between the various modules, circuits, functional blocks, components, devices, etc. within any of the various diagrams or as described herein may be differently implemented in different embodiments. For example, in one embodiment, such connections or couplings may be direct connections or direct couplings there between. In another embodiment, such connections or couplings may be indirect connections or indirect couplings there between (e.g., with one or more intervening components there between). Of course, certain other embodiments may have some combinations of such connections or couplings therein such that some of the connections or couplings are direct, while others are indirect. Different implementations may be employed for effectuating communicative coupling between modules, circuits, functional blocks, components, devices, etc. without departing from the scope and spirit of the invention.

Various aspects of the present invention have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Various aspects of the present invention have been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, various aspects of the present invention are not limited to such embodiments. It will be obvious to one of average skill in the art that various changes and modifications may be practiced within the spirit and scope of the invention, as limited only by the scope of the appended claims.

What is claimed is:

1. An apparatus, comprising:
a processing module for processing a media signal thereby identifying a characteristic associated there with, wherein:
the media signal including a video signal and an audio signal; and
the characteristic associated with the media signal being image information associated with at least one of a plurality of frames of the video signal; and
an audio processor for identifying at least one audio playback parameter based on the characteristic for use in playback of the audio signal to effectuate an audio effect corresponding to the characteristic.

2. The apparatus of claim 1, wherein:
the image information corresponding to at least one of a color, a contrast, a brightness, a background, a foreground, an object, an object location, a change of the color, a change of the contrast, a change of the brightness, a change of the background, a change of the foreground, a change of the object, and a change of the object location.

3. The apparatus of claim 1, wherein:
the processing module processing the media signal thereby identifying meta data associated with the media signal; and
the audio processor identifying the at least one audio playback parameter based on the meta data.

4. The apparatus of claim 1, further comprising:
an audio player including at least one speaker for outputting the audio signal in accordance with the at least one audio playback parameter.

5. The apparatus of claim 1, further comprising:
a display; and
an audio player including at least one speaker for outputting the audio signal in accordance with the at least one audio playback parameter when the display outputting the video signal.

6. The apparatus of claim 1, wherein:
the at least one audio playback parameter being at least one of a balance parameter, a fader parameter, an equalizer parameter, an audio effect parameter, a speaker parameter, a mono parameter, a stereo parameter, an audio high definition (HD) parameter, an audio three-dimensional (3D) parameter, and a surround sound parameter.

7. An apparatus, comprising:
an input for receiving a characteristic associated with a media signal including an audio signal; and
an audio processor for identifying at least one audio playback parameter based on the characteristic for use in playback of the audio signal to effectuate an audio effect corresponding to the characteristic.

8. The apparatus of claim 7, wherein:
the media signal also including a video signal; and
the characteristic associated with the media signal being image information associated with at least one of a plurality of frames of the video signal.

9. The apparatus of claim 7, wherein:
the media signal also including a video signal;
the characteristic associated with the media signal being image information associated with at least one of a plurality of frames of the video signal; and
the image information corresponding to at least one of a color, a contrast, a brightness, a background, a foreground, an object, an object location, a change of the color, a change of the contrast, a change of the brightness, a change of the background, a change of the foreground, a change of the object, and a change of the object location.

10. The apparatus of claim 7, wherein:
the audio processor modifying the audio signal of the media signal in accordance with the characteristic thereby generating a modified media signal; and further comprising:
a memory for storing the media signal and the modified media signal.

11. The apparatus of claim 7, wherein:
the characteristic associated with the media signal being meta data associated with the media signal.

12. The apparatus of claim 7, further comprising:
a processing module for processing the media signal thereby identifying the characteristic associated with the media signal and for providing the characteristic via the input.

13. The apparatus of claim 7, further comprising:
an audio player including at least one speaker for outputting the audio signal in accordance with the at least one audio playback parameter.

14. The apparatus of claim 7, wherein:
the media signal also including a video signal; and further comprising:
a display; and
an audio player including at least one speaker for outputting the audio signal in accordance with the at least one audio playback parameter when the display outputting the video signal.

15. The apparatus of claim 7, wherein:
the at least one audio playback parameter being at least one of a balance parameter, a fader parameter, an equalizer parameter, an audio effect parameter, a speaker parameter, a mono parameter, a stereo parameter, an audio high definition (HD) parameter, an audio three-dimensional (3D) parameter, and a surround sound parameter.

16. A method, comprising:
receiving a characteristic associated with a media signal including an audio signal; and
operating an audio processor for identifying at least one audio playback parameter based on the characteristic for use in playback of the audio signal to effectuate an audio effect corresponding to the characteristic.

17. The method of claim 16, further comprising:
processing the media signal thereby identifying the characteristic associated with the media signal and for providing the characteristic.

18. The method of claim 16, wherein:
the media signal also including a video signal;
the characteristic associated with the media signal being image information associated with at least one of a plurality of frames of the video signal; and
the image information corresponding to at least one of a color, a contrast, a brightness, a background, a foreground, an object, an object location, a change of the color, a change of the contrast, a change of the brightness, a change of the background, a change of the foreground, a change of the object, and a change of the object location.

19. The method of claim 16, wherein:
the media signal also including a video signal; and further comprising:
outputting the video signal via a display; and
outputting the audio signal in accordance with the at least one audio playback parameter when the display outputting the video signal.

20. The method of claim 16, wherein:
the at least one audio playback parameter being at least one of a balance parameter, a fader parameter, an equalizer parameter, an audio effect parameter, a speaker parameter, a mono parameter, a stereo parameter, an audio high definition (HD) parameter, an audio three-dimensional (3D) parameter, and a surround sound parameter.
